(19) United States
(12) Patent Application Publication
(10) Pub. No.: US 2024/0320611 A1
(43) Pub. Date: Sep. 26, 2024

(54) VESSEL LOADING WITH MACHINE LEARNING-GENERATED GUIDANCE

(71) Applicant: Inxeption Corporation, South San Francisco, CA (US)

(72) Inventors: Mark Moore, Burlingame, CA (US); Kartik Lakshminarayanan, Saratoga, CA (US)

(21) Appl. No.: 18/188,892

(22) Filed: Mar. 23, 2023

(51) Int. Cl. G06Q 10/083; G06Q 10/04; G06T 19/00

(52) U.S. Cl. CPC G06Q 10/0838; G06Q 10/04; G06T 19/006; G06T 2219/004; G06T 2219/016; G06T 2219/2004

(57) ABSTRACT

Techniques are described herein for guidance packing of vessels. In various implementations, a heterogeneous plurality of packages to be loaded into an interior of a vessel may be identified. In some implementations, physical characteristics of the heterogeneous plurality of packages may be determined on an individual package basis. Data indicative of the physical characteristics of the heterogeneous plurality of packages may be applied as input across a machine learning model to generate one or more outputs. The machine learning model may be trained based on historical examples of vessels being loaded with heterogeneous pluralities of packages. Based on one or more of the outputs, arrangement(s) of the heterogeneous plurality of packages within the interior of the vessel may be identified. Data indicative of one or more of the arrangements may be provided to one or more downstream computer-based actions.

### BACKGROUND

At various points of a package distribution network, different types of vessels are loaded with packages having varying sizes, shapes, and/or masses. For instance, at a manufacturing or distribution center, a set of packages may be loaded into a truck. At a container port, some of the set of packages may be removed from the truck and intermingled with other packages into a shipping container having different dimensions than the truck. At another location downstream from the container port, the packages may be unloaded from the shipping container and distributed among one or more additional vessels, such as trucks, train cars, etc., along with yet additional packages not included in the original set.

Without thoughtful consideration of how packages are arranged within vessels during each stage of distribution, individual packages may be lost, damaged, and/or destroyed. Additionally, packages may not be optimally positioned for downstream distribution. For example, packages in one vessel that are intended to be loaded together in a downstream vessel should be placed in close proximity with each other to reduce the likelihood that packages will be misplaced, and/or to improve logistical efficiency.

### SUMMARY

Implementations are described herein for leveraging artificial intelligence and/or machine learning to facilitate improved loading of packages into vessels at various stages of package distribution. More particularly, but not exclusively, techniques are described herein for training one or more machine learning models to generate output that conveys arrangements of packages within vessels that are likely to bolster efficiencies and/or reduce losses associated with distribution of the packages across the package distribution network. As used herein, a “vessel” may refer to anything that can be used to hold and/or move physical objects (e.g., packages) between physical locations, such as all or parts of ships or boats (e.g., cargo holds, cargo decks), semi-truck trailers, shipping containers that can be loaded onto trucks, ships, or trains, train cars, flat beds, panel trucks, vans, elevators, and so forth.

In some implementations, a method may be implemented by one or more processors and may include: identifying a heterogeneous plurality of packages to be loaded into an interior of a vessel; determining, on an individual package basis, physical characteristics of the heterogeneous plurality of packages; applying data indicative of the physical characteristics of the heterogeneous plurality of packages as input across a machine learning model to generate one or more outputs, wherein the machine learning model is trained based on historical examples of vessels being loaded with heterogeneous pluralities of packages; based on one or more of the outputs, identifying one or more arrangements of the heterogeneous plurality of packages within the interior of the vessel; and providing data indicative of one or more of the arrangements to one or more downstream computer-based actions.

In various implementations, the interior of the vessel may be logically divided into a three-dimensional (3D) array of logical cells, and the one or more outputs map the heterogeneous plurality of packages to the 3D array of logical cells. In various implementations, the one or more outputs may include, for each logical cell of the 3D array of logical cells, one or more probabilities that one or more individual packages of the heterogeneous plurality of packages should physically occupy that logical cell.

In various implementations, the one or more arrangements of the heterogeneous plurality of packages may include a plurality of layers of the packages. In various implementations, the machine learning model may be applied iteratively, with each iterative application of the machine learning model generating one or more of the outputs that represents a respective one of the plurality of layers of the packages. In various implementations, during a given iterative application of the machine learning model, data indicative of the physical characteristics of a subset of the heterogeneous plurality of packages already loaded into the vessel may be excluded from being applied as input across the machine learning model.

In various implementations, one or more of the downstream computer-based actions may include rendering, on a display, a visual depiction of the of one or more of the arrangements of the heterogeneous plurality of packages. In various implementations, one or more of the downstream computer-based actions may include rendering audio or visual output that conveys two or more arrangements of the heterogeneous plurality of packages as candidate arrangements, with each candidate arrangement being annotated with one or more assessments of the arrangement.

In various implementations, one or more of the downstream computer-based actions may include rendering, on one or more displays of an augmented reality (AR) display device, one or more annotations overlaying one or more digital images depicting the interior of the vessel, wherein the one or more annotations convey one or more aspects of one or more of the arrangements of the heterogeneous plurality of packages.

In various implementations, the method may further include: receiving feedback about one or more of the arrangements of the heterogenous plurality of packages; and training the machine learning model based on the feedback.

In various implementations, the data indicative of the physical characteristics of the heterogeneous plurality of packages may include individual masses of individual packages of the heterogeneous plurality of packages. In various implementations, the data indicative of the physical characteristics of the heterogeneous plurality of packages may include individual volumes of individual packages of the heterogeneous plurality of packages.

In various implementations, in addition to the data indicative of the physical characteristics of the heterogeneous plurality of packages, data indicative of a spatial characteristic of the interior of vessel may also be applied as input across the machine learning model. In various implementations, in addition to the data indicative of the physical characteristics of the heterogeneous plurality of packages, data indicative of scheduled downstream distribution of at least some of the packages, such as logistical relationships between packages (e.g., the packages be in the same downstream vessel(s)), may also be applied as input across the machine learning model.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example of how various components may cooperate to implement selected aspects of the present disclosure, in accordance with various embodiments.

FIG. 3A, FIG. 3B, FIG. 3C, FIG. 3D, and FIG. 3E depict an example process in which packages are loaded into a panel truck, as well as how the process and/or resulting arrangements of packages can be monitored for purposes of training machine learning models configured with selected aspects of the present disclosure.

FIG. 4A and FIG. 4B depict an example process in which packages are loaded into a panel truck with machine learning-based guidance, in accordance with various implementations.

FIG. 5A and FIG. 5B depict example machine learning architectures that may be deployed in various implementations.

FIG. 6 depicts a flowchart illustrating an example method for practicing selected aspects of the present disclosure.

FIG. 7 illustrates an example architecture of a computing device.

### DETAILED DESCRIPTION

Implementations are described herein for leveraging artificial intelligence and/or machine learning to facilitate improved loading of packages into vessels at various stages of package distribution. More particularly, but not exclusively, techniques are described herein for training one or more machine learning models to generate output that conveys arrangements of packages within vessels that are likely to bolster efficiencies and/or reduce losses associated with distribution of the packages across the package distribution network.

In various implementations, a heterogeneous plurality of packages that are to be loaded into a vessel (e.g., a truck, shipping container, rail car, crate, etc.) may be evaluated, e.g., to determine physical characteristics of the individual packages and/or logistical relationships between the packages. Physical characteristics of packages may include, but is not limited to, shapes, volumes, weights, constituent spatial dimensions (e.g., length, width, height), and/or masses of the individual packages. Physical characteristics of packages may also include a classification of matter within or otherwise associated with a package, such as solid, liquid, gas, and so forth. Logistical relationships between packages may include, for instance, identities of one or more downstream intermediate or final destinations (e.g., downstream vessels) that are shared by two or more packages.

In some cases, a package's physical characteristics and/or logistical relationships with other packages (collectively, “features” of the package) may give rise to one or more package constraints. Suppose a package includes matter that remains solid within a first temperature range but turns into liquid within a second temperature range. If there is a need or desire to maintain that matter in the solid state (e.g., keep a liquid frozen), then that package may have an associated package constraint of needing to be kept within the first temperature range. As another example, a package comprising liquid may be constrained to being loaded in particular locations within a vessel, such as on a bottom layer, or at a location at which the liquid's movement will not negatively impact the vessel's motion (e.g., in the center of the vessel, or balanced by another liquid-based package). A package's logical relationship with other packages may also impose package constraint(s). For example, two packages that are destined for the same downstream hub or destination may be subject to one or more package constraints that cause those packages to be bundled together across one or more vessels.

Package features may be determined in various ways. In some cases, identifiers of the packages (e.g., Global Trade Item Numbers, Universal Product Codes) may be associated in database(s) with various features of the packages. Lists of package identifiers—e.g., obtained from a log of packages to be loaded or scanned from fiducials on the packages themselves—can thereby be cross-referenced with those physical characteristics in the database(s). Additionally or alternatively, physical characteristics of the packages may be determined in situ using various sensors, such a digital cameras, light detection and ranging (LIDAR) sensors, infrared (IR) sensors, scales, and so forth. For example, a LIDAR sensor or three-dimensional (3D) digital camera can be operated to generate sensor data depicting a package, and the sensor data can be evaluated to determine a shape and/or volume of the package.

Once the packages' features are known, data indicative of the physical characteristics and/or logistical relationships between packages may be processed using one or more trained machine learning models to generate output. The output may be usable (e.g., interpretable) to identify one or more arrangements of those packages within an interior of a vessel. For example, in some implementations, a vessel's interior may be logically divided into a 3D array of logical cells, with each cell (or “voxel”) corresponding to one or more predetermined volumes. In some implementations, the 3D array of logical cells may be subdivided further, e.g., recursively, until, for instance, each cell is only occupied by a single package or not at all. The machine learning model may be used to generate output that maps the packages to these 3D cells. For instance, each cell may be classified with one or more probabilities that one or more of the packages should at least partially occupy that cell.

The data indicative of the packages' features that is processed using the machine learning model(s) may take various forms depending on, among other things, the architecture of the machine learning model(s). For example, in some implementations, physical characteristics of each package and/or a package's logistical relationship(s) with other package(s) may be encoded, e.g., using one hot or integer encoding, into a corresponding encoding (e.g., a vector or embedding of known dimensionality). In some implementations, encodings corresponding to individual packages may be combined, e.g., using concatenation, etc., to generate an aggregate encoding that conveys physical characteristics of multiple packages at once. For example, if a x by 1 vector is generated for each package, then a x by y vector may be generated for y distinct packages (x and y may be integers greater than zero). In other implementations, packages may be encoded into continuous embeddings, e.g., using a machine learning model that is trained to generate embeddings of similarly-sized/shaped packages that are near one another in embedding space.

Additionally or alternatively, in some implementations, the machine learning model may be configured to process multiple iterations (e.g., a sequence) of inputs, such as a set of encodings corresponding to a set of packages. At each iteration, the machine learning model may generate output that represents one or more arrangements of those packages for which encodings have been thus far processed. As additional encodings representing additional packages are processed, the output may assign those additional packages to logical cells of the vessel's interior in a manner that is optimal, given the already loaded packages. Various types of machine learning models may be used for iterative processing as described herein, including but not limited to a recurrent neural network (RNN), a long short-term memory (LSTM) network, a gated recurrent unit (GRU) network, and so forth. Additionally or alternatively, other types of sequence-to-sequence networks may be employed, including various types of transformers (which are often employed as large language models in other applications) such as a BERT (Bidirectional Encoder Representations from Transformers) transformer and/or a GPT (Generative Pre-trained Transformer), to name a few.

As noted previously, the output generated based on the machine learning model(s) may be usable to identify one or more arrangements of a set of heterogeneous packages within a vessel. In some implementations, the output may identify one or more candidate arrangements that each conveys a comprehensive layout of all packages to be loaded into the vessel at once. For example, a user may be presented with a 3D map that shows where each package of the set should be placed relative to the other packages. In some implementations, this 3D map may be selectively rendered as an “exploded” view that makes each package (and its spatial relationship to neighboring packages) more easily viewable.

In other implementations, the output may identify the packages one layer at a time. For instance, a first output generated during a first invocation of the machine learning model may identify a first layer of packages selected as a subset from the superset of packages. This output may also indicate a spatial arrangement of those packages within the layer. After the first layer of packages are loaded into the vessel (confirmed by user input or visually using various sensors), a second output generated during a second invocation of the machine learning model-during which encodings representing packages that remain outside the vessel after the first layer's packages are loaded—may identify a second layer of the packages. This may continue, layer by layer, until all packages are loaded into the vessel.

In some implementations, data other than physical characteristics of the packages may be processed using the machine learning model. For instance, data indicative of a spatial characteristic of the interior of vessel may be applied as an input across the machine learning model, e.g., as additional dimensions of encodings that also include physical characteristics of the packages or as separate encodings. In some implementations, the machine learning model may first be applied to the spatial characteristic data of the vessel's interior to “prime” or “condition” the model to predict arrangements of packages. Then, data indicative of the packages' physical characteristics may be applied across the primed/conditioned model subsequently to generate predicted arrangements of those packages within the vessel's interior.

As another example, logistical relationship data indicative of scheduled downstream distribution of at least some of the packages may be applied as input across the machine learning model. In some implementations, packages that are going to be loaded into the same vessel downstream from the current vessel may be annotated as such. For example, a given embedding dimension may be commandeered to identify a downstream vessel. Encodings representing packages to be loaded into that downstream vessel may each include the same downstream vessel identifier in the given dimension. Alternatively, packages that are to be loaded together downstream may be represented collectively as a graph, with other packages of the same load that have different downstream destination(s) not being included in the graph. However downstream package relationships are represented, the machine learning model may be trained to generate output that increases probabilities that packages that are to be kept together downstream are more likely to be loaded proximate each other within the current vessel.

Techniques described herein provided for various technical advantages. By training a machine learning model to approximate human expertise, packages may be loaded into vessels in ways that reduce the risk of packages being damaged and/or destroyed. By accounting for packages having the same intermediate or final destinations, packages can be loaded into vessels in a way that increases efficiencies for unloading the packages and/or reloading them in other vessels. Additionally, vehicles used as vessels, or used to transport vessels, may consume less feud (e.g., gasoline, diesel fuel, electricity, etc.) because packages are loaded in manners that will increase fuel efficiency, e.g., by ensuring equal or balanced distribution of weight.

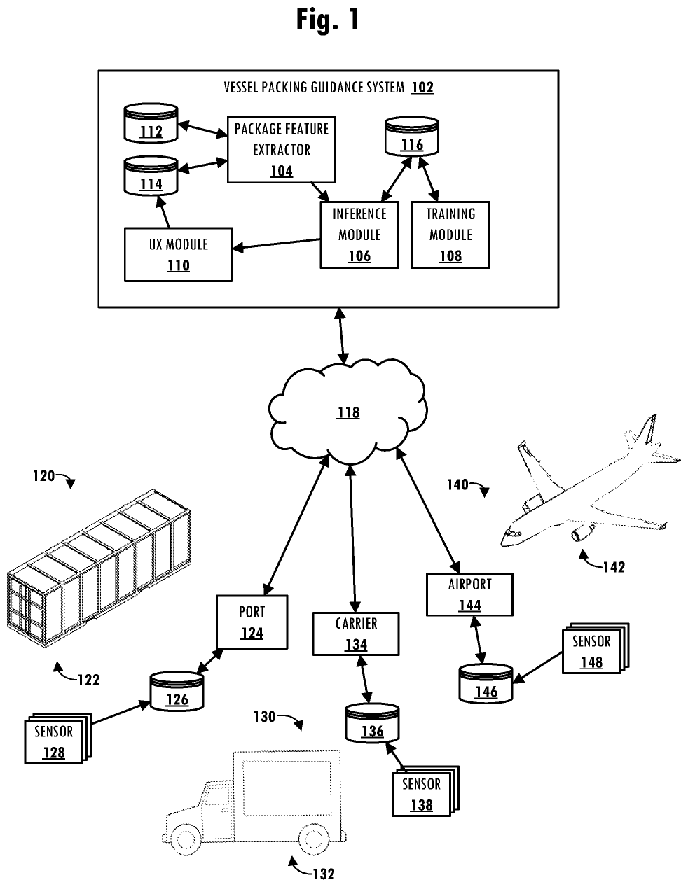

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”, tensor processing units or “TPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as a vessel packing guidance system 102, may be implemented using one or more server computing devices that form what is sometimes referred to as a “cloud infrastructure,” although this is not required.

Vessel packing guidance system 102 may be provided for helping various entities (including workers employed by entities) load packages into and/or onto vessels. As used herein, a “vessel” refers to any wholly or partially enclosed space that can be loaded with items and transported between locations. Non-limiting examples of vessels include shipping containers 122, panel trucks 132, airplanes 142, rail cars, trailers, boat holds and/or decks, and so forth.

Vessel packing guidance system 102 may include various components that may be implemented using any combination of hardware and software, and which may be configured to carry out selected aspects of the present disclosure. In FIG. 1, for instance, vessel packing guidance system 102 includes a package feature extractor 104, an inference module 106, a training module 108, and a user interface (UX) module 110. In other implementations, one or more of modules 104-110 may be combined, omitted, or implemented apart from vessel packing guidance system 102.

Package feature extractor 104 may be configured to process data indicative of packages to be loaded into a vessel to extract various package features. The data indicative of packages may be provided in various forms. In FIG. 1, for instance, data indicative of packages to be loaded into a vessel may be contained in a bill of lading database 112 that identifies individual packages, e.g., by identifiers such as Universal Product Codes (UPC). In some cases, bill of lading database 112 may include, or have access to, data indicative of physical characteristics of packages and/or logistical relationships between packages.

Data indicative of packages to be loaded into a vessel may also be contained in a package database 114 that can be populated in various ways. In some implementations, package database 114 may be populated via UX module 110. For example, a worker may operate a client computing device (e.g., 124, 134, 144) to provide data indicative of physical characteristics of the packages to be loaded into the vessel. These data may be provided to UX module 110, which in turn may populate database 114. Additionally or alternatively, the packages to be loaded into the vessel may be analyzed using one or more sensors, such as scales and/or various types of vision sensors. These raw data may be analyzed using various techniques to determine physical attributes of packages. These raw data and/or the determined physical attributes can be stored in database 114 so that they are available to package feature extractor 104.

The features extracted by package feature extractor 104 may be selected and/or formatted in various ways. In some implementations, package feature extractor 104 may extract, and generate a feature vector that includes in predefined slots, pieces of data about packages-to-be-loaded that are relevant to downstream operation. As one example, package feature extractor 104 may generate a separate feature vector for each package to be loaded into a vessel. The package feature vector may include, for instance, an identifier of the package (e.g., a UPC code), one or more physical characteristics of the package such as length, width, height, a mass of the package, a physical state of the package's contents (e.g., solid, liquid, gas), logistical relationships with other packages, and so forth. In other implementations, package feature extractor 104 may encode extracted package features into a continuous vector embedding. For instance, package feature extractor 104 may use a machine learning model (not depicted) that is trained using techniques such as triplet loss to embed similar packages and/or groups of heterogeneous packages near one another (e.g., in clusters) in embedding space.

Inference module 106 may be configured to process data generated by package feature extractor 104 using one or more machine learning models 116 to generate output. In some implementations, a database 116 may store the one or more machine learning models. The reference numeral 116 is used herein interchangeably to refer to this database and/or to the machine learning model(s) it stores. In various implementations, output generated by inference module 106 based on one or more of these machine learning models 116 may be indicative of how a set of heterogeneous packages should or can be arranged within a vessel. In some implementations, an interior of a vessel may be logically divided into a 3D array of logical cells. Output generated by inference module 106 may map the heterogeneous plurality of packages to the 3D array of logical cells. For example, the output may indicate, for each logical cell of the 3D array of logical cells, one or more probabilities that one or more individual packages of the heterogeneous plurality of packages should physically occupy that logical cell.

Trained machine learning models 116 may take various forms, including but not limited to BERT transformers, GPT transformers, a graph-based network such as a graph neural network (“GNN”), graph attention neural network (“GANN”), or graph convolutional neural network (“GCN”), other types of models and/or encoder-decoders, various flavors of a recurrent neural network (RNN, LSTM, GRU, etc.), and any other type of machine learning model that may be applied to facilitate selected aspects of the present disclosure.

Training module 108 may be configured to train one or more of the machine learning models 116 based on various signals, e.g., using techniques such as gradient descent and back propagation. These signals may include, for instance, human feedback that accepts, rejects, or modifies one or more candidate arrangements of packages provided in output generated by inference module 106. For example, if a worker follows an arrangement of packages represented in output generated by inference module 106 when loading a container, training module 108 to train one or more machine learning models using that positive feedback. As another example, when a worker explicitly rejects a proposed arrangement of packages, e.g., by providing explicit feedback at a computing device or by loading packages differently than recommended, training module 108 may use that as a negative training example to train the machine learning model.

UX module 110 may be configured to receive inferences generated by inference module 118, process those inferences as needed, and present those inferences or data indicative thereof to interested parties. For example, UX module 110 may, based on output generated by inference module—e.g., probabilities that packages should at least partially occupy particular 3D cells that are logically defined within an interior of the vessel—generate a two-dimensional (2D) or 3D map of an arrangement of at least some of the packages. This map may include one or more candidate arrangements of how those packages should be loaded within the interior of the vessel. In some implementations, UX module 110 may present a package arrangement as an interactive map that can, for instance, be transitioned into an exploded view in which individual packages and their spatial relationships with other packages are more easily viewed. Depending on the output of inference module 106, UX module 110 may present an entire mapping of all packages to be loaded into a vessel at once, or UX module 110 may present packages one layer at a time. As noted elsewhere herein, these layers may change depending on whether workers accept them (e.g., by loading the packages in the recommended arrangement) or reject them (e.g., by loading the packages differently than recommended).

Also depicted in FIG. 1 are some examples of the types of logistical hubs that may take advantage of selected aspects of the present disclosure. Each of these hubs (120, 130, 140) includes one or more computing systems (e.g., 124, 134, 144) that are operably coupled with vessel packing guidance system 102 via one or more local area and/or wide area networks 118, such as the Internet.

A first logistical hub takes the form of a port 120 at which shipping containers 122 are loaded with packages/items. Port 120 may include, e.g., onsite or remotely connected thereto, one or more port computing systems 124 that may be configured to implement selected aspects of the present disclosure. For example, a port system 124 may be connected to a database 126 that includes local copies or versions of modules 104-110 and/or machine learning models 116.

In some implementations, one or more sensors 128 may be deployed at port 120 and operably coupled with port system(s) 124. These sensor(s) 128 may monitor how packages are unloaded from and/or loaded into vessels such as shipping container 122. To this end, port sensor(s) 128 may include, for instance, 2D, 2.5D, and/or 3D digital cameras (e.g., depth cameras, stereoscopic cameras, etc.), infrared cameras and/or projectors (e.g., to determine scale and/or determine sizes of objects), LIDAR sensors, and so forth. Port sensor(s) 128 may be deployed at various locations outside of, on, or within shipping container(s) 122 so that they capture data evidencing how packages were loaded into an interior of shipping container(s) 122. In some implementations, one or more sensors 128 may be carried by workers, e.g., as wearable devices such as body cams or the like, so that they are able to record how packages are loaded into shipping container(s) 122.

Like port 120, a carrier 130 may by any location (e.g., distributor) at which packages are unloaded from and/or loaded into trucks and/or trailers, such as panel truck(s) 132, semi-trucks, etc. Carrier 130 may include, e.g., onsite or remotely connected thereto, one or more computing systems 134 that may be configured to implement selected aspects of the present disclosure. For example, a carrier system 134 may be connected to a carrier database 136 that includes local copies or versions of modules 104-110 and/or machine learning models 116.

In some implementations, one or more carrier sensors 138 may be deployed at carrier 130 as well. As was the case with port sensors 128 at port 120, carrier sensor(s) 138 at carrier 130 may monitor how packages are unloaded from and/or loaded into vessels such as panel truck 132. To this end, carrier sensor(s) 138 may include, for instance, 2D, 2.5D, and/or 3D digital cameras, infrared cameras, LIDAR sensors, and so forth. Carrier sensor(s) 138 may be deployed at various locations outside of, on, or within shipping panel truck(s) 132 so that they capture data evidencing how packages were loaded into an interior of panel truck(s) 132. In some implementations, one or more carrier sensors 138 may be carried by workers, e.g., as wearable devices such as body cams or the like, so that they are able to record how packages are loaded into panel truck(s) 132.

Airport 140 may have a similar arrangement of components as port 120 and carrier 130, except that one or more airplanes 142 are loaded with packages. For example, airport 140 may include any number of computing devices or systems 144 that perform similar functions as devices/systems 124, 134, except in the airport context. Likewise, airport 140 may include database(s) 146 that store similar data as databases 126, 136, and airport sensor(s) 148 that are used similarly as port sensors 128 and/or carrier sensors 138.

Any of systems 124, 134, 144 may exchange various data with vessel packing guidance system 102 in order to facilitate techniques described herein. During training-which may continue even after the machine learning models 116 have reached some level of convergence in order to keep the models up to date-sensor data captured by sensors 128, 138, 148 may be directly (as raw data) or indirectly (e.g., as reduced dimensionality embeddings) provided by systems 124, 134, 144 to vessel packing guidance system 102. Vessel packing guidance system 102, and in particular, training module 108, may use this data to train one or more machine learning models 116 as described herein.

In some implementations, at least a portion of training may occur outside of vessel packing guidance system 102. For instance, one or more of systems 124, 134, 144 may include local instances (not depicted) of inference module 106 and/or training module 108. These local instances may cooperate in a federated learning framework with vessel packing guidance system 102. The local instances of modules 106, 108 may apply and train local instances of machine learning models 116 (which may be duplicates of those found on vessel packing guidance system 102 or reduced dimensionality versions thereof) to learn “local gradients.” These local gradients may then be propagated from systems 124, 134, 144 through network(s) 118 to vessel packing guidance system 102, where training module 108 may update machine learning model(s) 116 based on these local gradients. In some implementations, training module 108 may send updated machine learning model weights back down to systems 124, 134, 144, e.g., so that relevant training that occurs at port 120, for instance, may be leveraged at carrier 130 and/or at airport 140 via the federated learning framework.

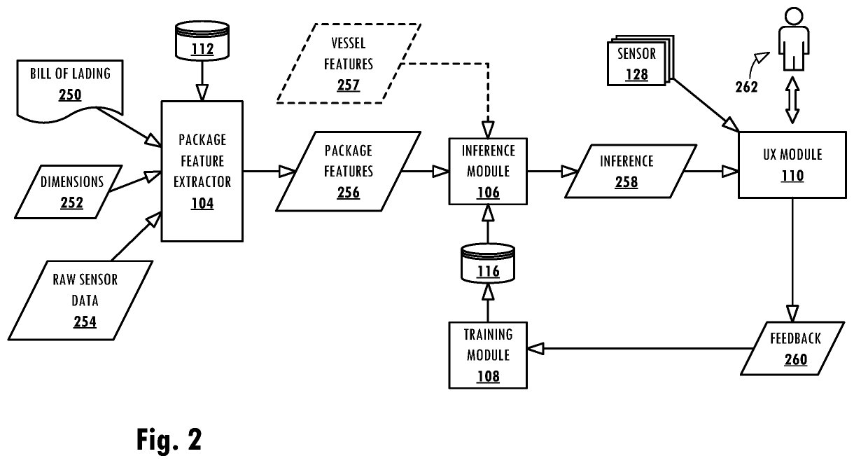

FIG. 2 schematically depicts on example of how various components depicted in FIG. 1 may cooperate to perform selected aspects of the present disclosure. Starting at left, various types of data 250-254 may be provided to package feature extractor 104. Package feature extractor 104 may extract various package features 256 from data 250-254 and provide the extracted features 256 to one or more downstream computing processes. These package features 256 may include various data, including but not limited to physical characteristics of the individual packages, such as mass, weight, length, width, height, depth, etc., states of the packages' contents (e.g., solid, liquid, gas), logistical relationships between packages such as intermediate and/or final destinations of individual packages (e.g., packages heading to the same or similar logical waypoints or destinations may be grouped together to gain efficiencies), costs associated with the packages, insurance coverage for individual packages or the packages as a whole, and so forth.

Bill of lading data 250 may include one or more lists of packages to be loaded into an interior of a vessel. Bill of lading data 250 may include various levels of detail. In some cases, bill of lading data 250 may explicitly provide various features of individual packages, including physical characteristics of the individual packages, such as mass, volume, weight, length, width, height, depth, etc., as well as other package features such as one or more of those mentioned previously. In other cases, bill of lading data 250 may provide information that is usable to obtain features (e.g., physical characteristics) of the individual packages and/or logistical relationships between packages. For example, bill of lading data 250 may provide identification information (e.g., UPC codes) that can be used, e.g., by package feature extractor 104, to retrieve, e.g., from bill of lading database 112, package physical characteristics associated with the identification information.

Another type of data that may be provided to package feature extractor 104 is package dimensions data 252. Package dimensions data 252 may simply include various physical characteristics of packages to be loaded into a vessel. In some implementations, package dimensions data 252 may be provided manually by a user, e.g., a worker operating one of systems 124, 134, 144, via UX module 110. Additionally or alternatively, package dimensions data 252 may be determined automatically, e.g., by processing sensor data captured by sensors 128, 138, 148. In some implementations, package dimensions may be calculated, e.g., by one or more of systems 124, 134, 144, using various object detection techniques. In some implementations, one or more of systems 124, 134, 144 or another component may calculate package dimensions by determining distances to the packages, and then calculating the packages' dimensions based in part on those distances. In some implementations, a sensor such as a 3D camera may project patterns (e.g., infrared checkerboards) onto surfaces, e.g., as reference scales against which packages can be measured. Additionally or alternatively, package dimensions data 252 may be determined by package feature extractor 104 itself based on raw sensor data 254 retrieved from sensors (e.g., 128, 138, 148).

However package features 256 are determined, inference module 106 may process package features 256 based on one or more machine learning models 116 to generate one or more inferences 258. As shown by the dashed lines, in some implementations, inference module 106 may also process one or more vessel features 257 into which the packages are being loaded as inputs to one or more of the machine learning models 116. Vessel features 257 may include, for instance, physical dimensions of the vessel's interior, available capacity within the interior of the vessel (e.g., there may be a constraint to preserve some capacity for additional payload from elsewhere), physical characteristics of the vessel (e.g., maximum load, compatibility with various vehicles), other features of the vessel (e.g., refrigeration, insulation, etc.), and so forth.

Inference(s) 258 may include information that is usable to identify arrangement(s) of a heterogeneous plurality of packages within the interior of the vessel at issue. In some implementations, the interior of the vessel may be logically divided into 3D cells, e.g., based on vessel features 257. In some such cases, inference(s) 258 may include probabilities that one or more individual packages of the heterogeneous plurality of packages should physically occupy each logical cell. For instance, inference(s) 258 could include a probability distribution across the plurality of 3D cells, e.g., for each package, groups of packages, etc.

As noted previously, in some implementations, inference module 106 may apply one or more machine learning model(s) iteratively. Each iterative application of machine learning model(s) 116 by inference module 106 may generate one or more inferences 258 that represents a respective layer of the packages within the vessel's interior. During a given iterative application of machine learning model(s) 116 by inference module 106, data indicative of a subset of heterogeneous plurality of packages that are already loaded into the vessel may be excluded from being applied as input across the machine learning model. Intuitively, if some packages have already been loaded, those loaded packages should not be considered when inferring new arrangements of the packages that remain to be loaded into the vessel's interior.

Referring back to FIG. 2, in some implementations, inference(s) 258 may be provided to UX module 110. Based on inference(s) 258, UX module 110 may present arrangement(s) of packages to a worker 262 in various ways, such as visually, audibly (e.g., computer-generated speech that includes a series of instructions to be followed to load packages into the vessel's interior), and so forth. In some implementations, one or more sensors 128, 138, 148 may monitor how worker 262 actually loads the packages into the vessel's interior. Whether worker 262 accepts or rejects a proposed package arrangement, that may be detected, for instance, by comparing a “ground truth” arrangement of packages observed by sensor(s) to the proposed arrangement. In some implementations, this ground truth arrangement of packages may be provided, e.g., by UX module 110, as feedback 260 to be used by training module 108 to train and/or fine-tune machine learning model(s) 116.

Alternatively, worker 262 may interact with a GUI to explicitly accept or reject the proposed arrangement(s) of packages. For example, in some implementations, UX module 110 may present a proposed arrangement of packages as an exploded (or expandable) 3D view of the packages within the vessel's interior. Individual packages of the exploded view may be interactive, e.g., so that worker 262 can drag them relative to each other to form alternative arrangements of packages (this technique could also be used during training when there are no real world packages to load).

In various implementations, the outcome of UX module 110 presenting the proposed package arrangement(s) to worker 262 may be used, e.g., as feedback 260 by training module 108, to train and/or fine-tune machine learning model(s) 116. For example, a difference or error between whatever package arrangement(s) are ultimately used by worker 262 when loading packages and the proposed package arrangements may be used by training module 108 to train and/or fine-tune machine learning model(s) 116 using techniques such as gradient descent, back propagation, etc.

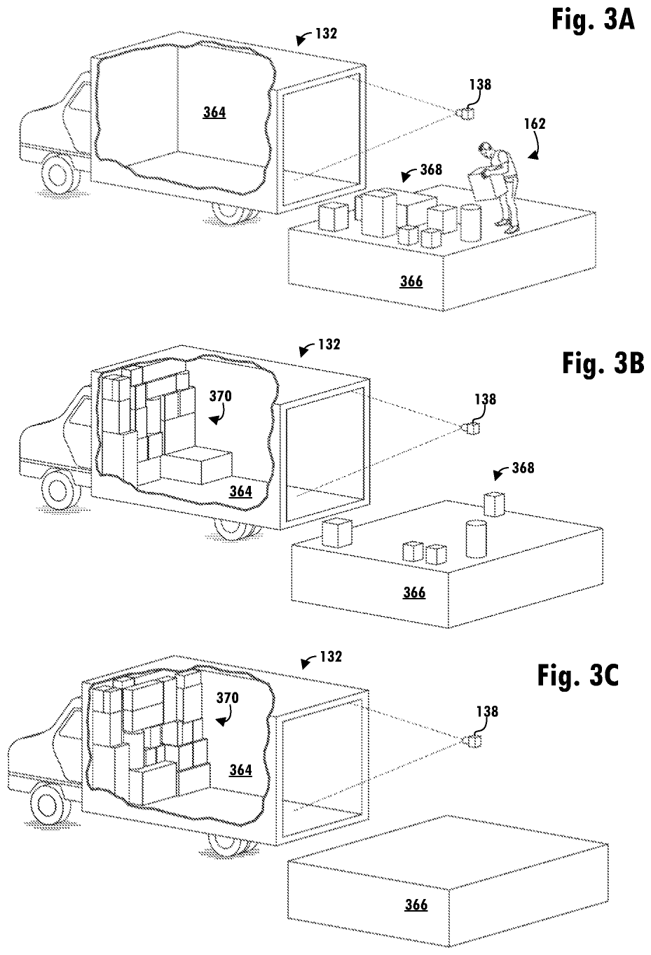

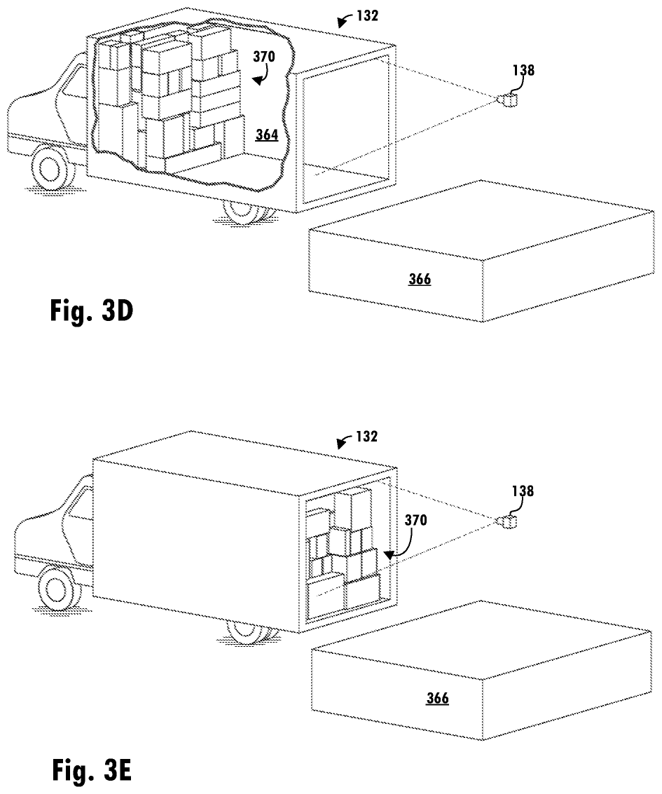

FIGS. 3A-E demonstrate one example of how techniques described herein may be used, e.g., by training module 108, to train a machine learning model based on observing how packages are loaded into a vessel. In FIG. 3A, panel truck 132 is depicted with an interior 364 that is to be loaded by a worker 262 with a heterogeneous plurality of packages 368 that are positioned on a loading dock 366. Interior 364 in FIG. 3A is empty because worker 262 has not yet begun loading packages 368. Packages 368 are described as “heterogeneous” because there are individual packages that have different sizes, shapes, masses, contents, etc. from other individual packages. The term “heterogeneous,” when used herein to describe a set of packages to be loaded into a vessel, does not preclude the possibility that at least some packages may be identical to each other—it only means that at least some packages are different than others.

A vision sensor 138 is also provided, e.g., in the form of a 3D digital camera, LIDAR sensor, etc. Vision sensor 138 is deployed outside of panel truck 132 and is depicted as being oriented so that its field of view (FOV) captures interior 364 of panel truck 132. However, this is not meant to be limiting. One or more vision sensors may be deployed at other locations as well, such as within interior 364 of panel truck 132, as a wearable sensor (e.g., body cam) carried by worker 262, or even as a portable vision sensor that worker 262 operates manually to periodically capture observations of packages loaded into interior 364 of panel truck 132 and/or of packages 368 that remain on loading dock 366. This sensor data may be analyzed as described previously, e.g., by package feature extractor 104 or another component (e.g., carrier system 134), to extract various package features 256 (and/or vessel features 257), such as physical characteristics of packages 368.

Additionally, sensor 138 and/or one or more other sensors (not depicted) may be capable of capturing packages 368 on loading dock 366 that are to be loaded into interior 364 of panel truck 132. For instance, vision sensor 138 may be operated to point its FOV toward loading dock. Additionally or alternatively, a separate vision sensor (not depicted) may be used to capture packages 368 on loading dock 366. Additionally or alternatively, physical characteristics of packages 368 on loading dock 366 may be determined from bill of lading data 250, as described previously.

In FIG. 3B, a subset 370 of packages 368 have been loaded into interior 364 of panel truck 132. This loading activity and/or the arrangement of the subset 370 of packages may be captured by sensor 138, e.g., as it happens and/or once the subset 370 of packages is loaded. Layers may be vertically stacked as depicted in FIG. 3B-3E, or they may be horizontal (e.g., a layer on the floor of the vessel). It can be seen in FIG. 3B that the number of packages 368 remaining on loading dock 366 is reduced from the number shown in FIG. 3A. FIG. 3C depicts a later stage of the loading process where the subset of packages 370 that are loaded into interior 364 of panel truck has grown, and there are fewer packages (none in this example) on loading dock 366. As before, sensor 138 may capture the loading activity and/or resulting arrangement of the subset of packages 370 within interior 364 of panel truck 132.

FIG. 3D depicts a subsequent stage of the loading process where the subset of packages 370 that are loaded into interior 364 of panel truck has grown even more than what was depicted in FIG. 3C. Once again, sensor 138 may capture the loading activity and/or resulting arrangement of the subset of packages 370 within interior 364 of panel truck 132 in FIG. 3D. The loading process may continue in this fashion until, for instance, interior 364 of panel truck 132 is fully loaded, as depicted in FIG. 3E, and/or until circumstances otherwise dictate that loading of interior 364 of panel truck 132 is complete (e.g., if panel truck 132 reaches a maximum permitted weight, no more packages may be loaded, even if interior 364 has remaining capacity).

During the loading process depicted in FIGS. 3A-E, training module 108 may train one or more machine learning models 116 in various ways. In some implementation, package features (256 in FIG. 2) extracted from sensor data captured by sensor 138 may be processed, e.g., by inference module 106 and/or training module 108, to generate output(s) (e.g., inference 258 in FIG. 2). These output(s) may be usable, e.g., by a component of vessel packing guidance system 102 such as UX module 110, to identify one or more potential or “candidate” arrangements of the heterogeneous plurality of packages 368 within interior 364 of panel truck 132. Each candidate arrangement may include all, or a subset of, the whole plurality of packages 368. For example, in some implementations, each candidate arrangement may include a candidate arrangement of a subset of plurality of packages 368, e.g., enough to create a layer of packages within interior 364 of panel truck 132.

Meanwhile, the actions of worker 262 and/or actual arrangement(s) of the plurality of packages 368 may be observed by sensor 138 (and any other sensors that might be present) as “ground truth” data. The candidate arrangement(s) generated by inference module 106 or training module 108 may be compared with the ground truth data (i.e. actual arrangement(s) of packages within interior 364 of panel truck 132) and/or to assessments assigned (e.g., by humans) to those ground truth arrangements, to determine one or more error(s). Training module 108 may use these errors to train one or more of the machine learning models 116, e.g., using techniques such as gradient descent, back propagation, cross entropy as a loss function, etc. Over a large number of instances in which this training process is implemented while workers are observed loading vessels with packages, the machine learning model(s) may “learn” to generate outputs that include more efficient and/or less risky arrangements of packages within vessel interiors.

Different arrangements of packages may yield different outcomes, both positive and negative. For example, a particular arrangement of packages loaded into a particular vessel may have resulted in a significant portion of those packages being damaged during shipping. The arrangement of packages that resulted in that negative outcome may be assessed, e.g., by one or more people (e.g., the end recipients, shippers, carriers, etc.), and assigned various metrics, including a metric conveying the amount of packages damaged. During training of the machine learning model, the weights of the model may be altered to lessen the chance of a similar arrangement of packages being suggested in the future.

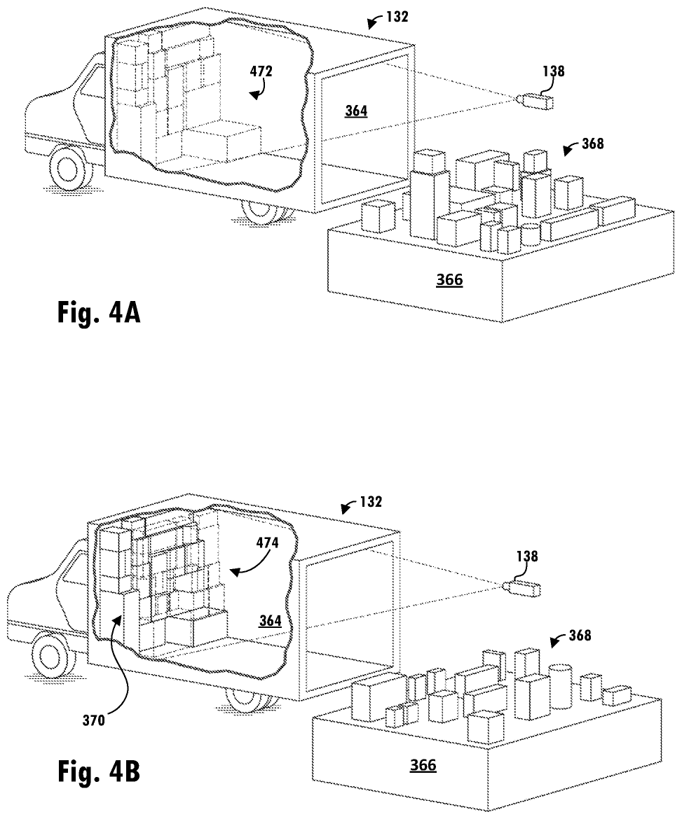

FIGS. 4A-B depict an example of how techniques described herein may be implemented during an inference stage to guide one or more workers (not depicted in FIGS. 4A-B, see FIG. 3A or FIG. 2) on how to load packages into a vessel's interior. In this example, the vessel is once again panel truck 132 having an interior 364. A nearby loading dock 366 is once again stocked with a heterogeneous plurality of packages 368 that are to be loaded into interior 364 of panel truck 132.

In FIG. 4A, various features (e.g., 256 in FIG. 2) of packages 368 are processed, e.g., by inference module 106 based on one or more trained machine learning models 116. The output generated from this processing may be usable to present, e.g., on a display screen, one or more candidate arrangements 472 of packages within interior 364 of panel truck 132. In FIG. 4A, a candidate arrangement 472 is depicted in dashed line to indicate that they are not yet loaded into interior 364 of panel truck 132. In this example, candidate arrangement 472 of packages is in the form of a layer of packages arranged against an interior wall of panel truck 132. As noted elsewhere herein, in some implementations, packages may be processed into candidate arrangements within a vessel's interior one layer at a time. This may be easier for a worker to follow than if a comprehensive candidate arrangement of all packages within a vessel's interior was provided.

FIG. 4A is not meant to show precisely how candidate arrangements 472 of packages are presented to a user. Rather, FIG. 4A is meant to demonstrate how a candidate arrangement 472 presented to a user (e.g., on a 2D display screen) would actually be arranged within interior 364 of panel truck 132. However, it is contemplated that in some implementations, the perspective view shown in FIGS. 4A-B could be presented to the user, e.g., on a display, as a perspective and cutout view of panel truck 132 that frames the candidate arrangement 472 of packages. In other implementations, candidate arrangements 472 of packages may be presented as 2D and/or 3D maps, and/or as 3D views that are can be “exploded” to add artificial space between individual packages, e.g., so that a user can more easily see and interact with individual packages.

FIG. 4B shows panel truck 132 during a subsequent stage of loading. In FIG. 4B, the candidate arrangement 472 of packages depicted in FIG. 4A was followed, as evidenced by the actual (or “ground truth”) arrangement 370 of packages loaded in interior 364 of panel truck 132 (the real packages are depicted in solid lines). A new candidate 474 arrangement of packages is shown in dashed lines as a next layer within interior 364 of panel truck 132. It can be seen that packages forming the actual layer 370 of packages already loaded into interior 364 of panel truck 132 are no longer on loading dock 366, and a smaller number of packages to be loaded remains.

The process depicted in FIGS. 4A-B may continue, e.g., layer by layer within interior 364 of panel truck 132, until for instance, there are no remaining packages to load, the truck is full or satisfies some other criterion (e.g., maximum weight, maximum value of packages contained within, etc.), and so forth. At each iteration/layer, worker(s) may follow the guidance provided by the candidate arrangement (472, 474, . . . ) of packages presented to them. Should worker(s) deviate from the candidate arrangement provided during a given iteration, the ground truth arrangement of loaded packages (370) actually loaded into interior 364 of panel truck 132 may be accounted for during the next iteration/layer. For example, package features (e.g., 256 in FIG. 2) of the packages 368 remaining on loading dock 366 may be resampled, e.g., using data sensor 138, and used by inference module 106 to generate a new candidate arrangement of packages as a next layer within interior 364 of panel truck 132. Moreover, this difference between proposed and ground truth arrangements of packages may be used, e.g., by training module 108, to perform ongoing training of machine learning model(s) 116.

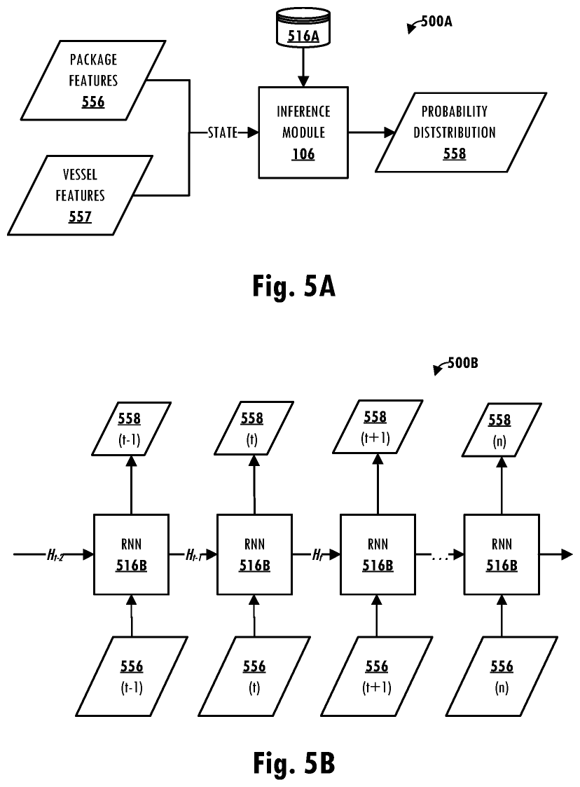

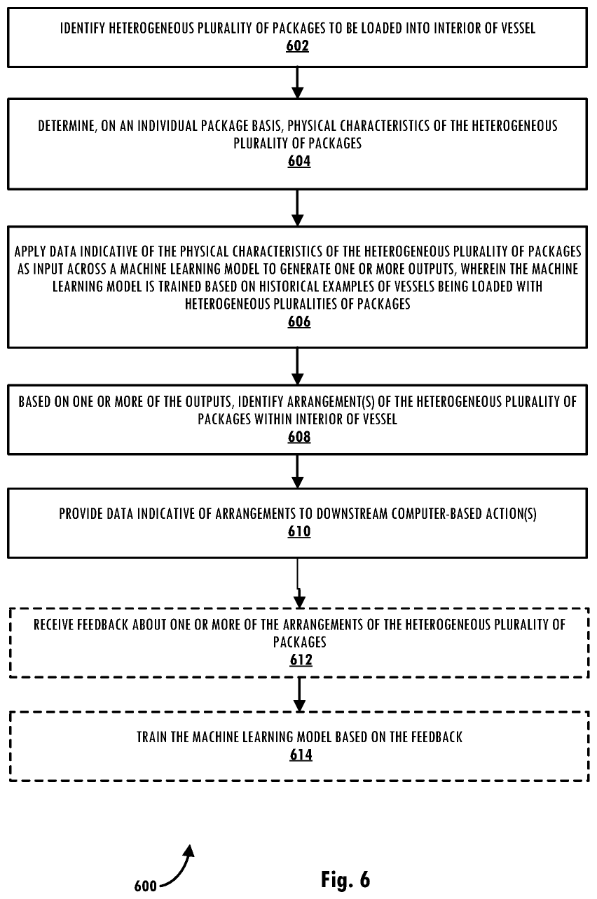

Inference module 106 may leverage various types of machine learning models 116 and/or machine learning architectures to perform selected aspects of the present disclosure. Non-limiting examples are depicted in FIGS. 5A and 5B. In FIG. 5A, an example machine learning architecture 500A includes a machine learning model in the form of a reinforcement learning (RL) policy 516A that is so-named because it was trained using reinforcement learning. RL policy 516A may take various forms, such as various types of neural networks (e.g., feedforward, multi-layered perceptron, convolutional neural network, etc.), a generative model such as a BERT transformer or GPT transformer, and so forth.

In various implementations, RL policy 516A may be trained so that it can be used at each iteration (or “turn”) of a plurality of iterations to generate output (e.g., inference 258) that is usable to identify candidate arrangement(s) (e.g., 472, 474) of the heterogeneous plurality of packages within an interior of a vessel. In FIG. 5A, for instance, package features 556 provided by package feature extractor 104 (not depicted in FIG. 5A) and vessel features 557 (e.g., similar to 257 in FIG. 2) may be processed by inference module 106 together, e.g., as a “state” of the current environment, using RL learning policy 516A. Based on the processing of the state of the environment, inference module 106 may generate one or more probability distributions 558 over, for instance, a plurality of logical 3D cells that are defined within a vessel's interior. In particularly, one or more of the probability distributions 558 may indicate a probability that a given logical 3D cell will be at least partially occupied by one or more packages to be loaded.

In some implementations in which RL policy 516A is implemented as a transformer, a respective feature vector or embedding representing each package may be provided as a set of inputs (e.g., tokens) for RL policy 516A. For example, the set of inputs may be represented as an x by y matrix. x may be the number of features (or more generally, dimensions) used to represent each individual package. y may be the number of packages that remain to be loaded. The output generated using such a transformer RL policy 516A (or by one or more additional downstream activation functions/layers, such as a softmax layer) may include, for instance, representation(s) (e.g., feature vector(s), embedding(s)) corresponding to at least a subset of the packages that remain to be loaded (e.g., as a layer within the vessel's interior) and an indication of which logical 3D cell each package should occupy.

To use a transformer as RL policy 516A, the transformer may be trained, in some implementations, on a large corpus of training examples. These training examples may be generated, for instance, by monitoring numerous instances in which packages were loaded into vessels, one instance of which was demonstrated in FIGS. 3A-E. Each training example may include features (e.g., 556) of a respective heterogeneous plurality of packages, as well as data indicative of resulting arrangement(s) (e.g., 558) of at least some of those packages within a vessel's interior. In some cases, each training example may also include features (e.g., 557) of the vessel into which the packages were loaded. Self-supervised learning may be employed so that that transformer learns a mapping between heterogeneous sets of packages and ground truth arrangements of those packages within vessels of various sizes and shapes. Once trained (which may include fine tuning for different types of vessels), the transformer may be used to process state data (e.g., 556, 557) to predict probability distributions (e.g., 558) indicative of arrangements of packaged within vessel interiors.

FIG. 5B depicts an alternative machine learning architecture 500B to that 500A of FIG. 5A. In FIG. 5B, machine learning architecture 500B includes an RNN 516B. RNN 516B may take various forms, such as a standard recurrent neural network, long short-term memory network (LSTM), or a gated recurrent unit (GRU) network, to name a few. RNN 516B is depicted in FIG. 5B in an unfolded state to demonstrate how it may be applied over multiple iterations t−1, t, t+1, . . . n.

At each iteration, RNN 516B receives an input in the form of package features 656, as well as passthrough data H (e.g., acting as a form of memory) from a previous iteration, and generates an output 558. The package features 556 provided as input at each iteration may include, for instance, features of packages that remain to be loaded into the vessel's interior. The passthrough data H may represent, for instance, a current state of the vessel's interior at the end of the previous iteration. The output 558 at each iteration may include data that is usable, for instance, to identify or convey one or more candidate arrangements (e.g., layers) of packages within a vessel's interior. Thus, for instance, output 558 at t−1 may represent a first candidate arrangement (e.g., layer) of packages to be loaded into a vessels interior. Output 558 at t may represent a second candidate arrangement (e.g., layer) of packages to be loaded into the vessel's interior in front of (or on top of) the first layer. And so on.

FIG. 6 is a flowchart illustrating an example method 600 of performing selected aspects of the present disclosure, in accordance with various implementations. For convenience, the operations of the flow chart are described with reference to a system that performs the operations. This system may include various components of various computer systems, such as one or more components of vessel packing guidance system 102. Moreover, while operations of method 600 are shown in a particular order, this is not meant to be limiting. One or more operations may be reordered, omitted or added.

At block 602, the system, e.g., by way of package feature extractor 104, may identify a heterogeneous plurality of packages to be loaded into an interior of a vessel. For example, bill of lading data 250, package dimensions data 252, and/or raw sensor data 254, may be provided to package feature extractor 104.

At block 604, the system, e.g., by way of package feature extractor 104, may determine, e.g., on an individual package basis, physical characteristics of the heterogeneous plurality of packages such as sizes, shapes, contents, content states, etc. For example, package feature extractor 104 may consult bill of lading data 250 and database 112 to determine physical characteristics. Additionally or alternatively, package physical characteristics may be determined from raw sensor data 254. In some implementations, other data may be determined by package feature extractor 104. For example, package feature extractor 104 may determine logistical relationship data such as intermediate and/or final destinations of individual packages. To the extent two or more packages have similar intermediate or final destinations, the various machine learning models (e.g., 116, 516A, 516B, transformer, etc.) may be trained and/or fine-tuned to ensure that those packages are loaded in a vessel in close proximity to each other.

At block 606, the system, e.g., by way of inference module 106, may apply data indicative of the physical characteristics of the heterogeneous plurality of packages as input across a machine learning model 116 to generate one or more outputs. As noted elsewhere herein, the machine learning model may be trained based on historical examples of vessels being loaded with heterogeneous pluralities of packages.

Based on one or more of the outputs, at block 608, the system, e.g., by way of inference module 106 or UX module 110, may identify one or more arrangements of the heterogeneous plurality of packages within the interior of the vessel. In some implementations, the outputs may map the heterogeneous plurality of packages to a 3D array of logical cells (e.g., voxels) into which the vessel's interior is logically divided. For example, the output or inference (258 in FIG. 2) generated by inference module 106 may include one or more probability distributions over the plurality of 3D cells. These probability distribution(s) may be interpreted, e.g., by UX module 110, to generate a 3D map in which the 3D cells are at least partially occupied by 3D renderings of the packages.

At block 610, the system, e.g., by way of UX module 110, may provide data indicative of one or more of the arrangements (e.g., the 3D map) to one or more downstream computer-based actions. One downstream computer-based action may be a logistics application operating on one of systems 124, 134, 144 that instructs workers at port 120, carrier 130, or airport 140 how to load packages into vessels such as shipping container 122, panel truck 132, or airplane 142. This instruction may be visual in many cases, e.g., rendered on a display as a 3D map of packages that demonstrates the packages physical relationships with each other within the vessel's interior.

In other implementations, a downstream computer-based action may include rendering audio or visual output that conveys two or more arrangements of the heterogeneous plurality of packages as candidate arrangements. Each candidate arrangement may be annotated with one or more assessments of the arrangement. For example, a first candidate arrangement may be associated with a strong measure spatial efficiency, e.g., because the packages in the first arrangement efficiently fill a vessel's interior without wasting much space. However, the first candidate arrangement may also be associated with a weak measure of package proximity efficiency. While the packages may be packed tightly and minimal space may be wasted, packages with same intermediate and/or final destinations may not be as proximate to each other as possible, resulting in inefficiencies when the packages are unloaded and/or reloaded into a different vessel. These types of assessments may be generated, for instance, by training the machine learning model(s) 116 to generate them based on human labels identifying assessments of historical loads.

In some implementations, one or more of the downstream computer-based actions may include rendering, on one or more displays of an augmented reality (AR) display device worn by a worker 262, one or more annotations overlaying one or more digital images depicting the interior of the vessel. In various implementations, the one or more annotations may convey one or more aspects of one or more of the arrangements of the heterogeneous plurality of packages.

Referring back to FIG. 6, at optional block 612, the system, e.g., by way of UX module 110 and/or by way of sensor data captured by one or more sensors (e.g., 128, 138, 148), may receive feedback (e.g., 260) about one or more of the arrangements of the heterogeneous plurality of packages. For example, a worker may explicitly reject a candidate arrangement, may reorganize the candidate arrangement (e.g., by dragging graphical elements representing packages to different relative locations using a GUI), or may load packages into the vessel in an arrangement that does not match any candidate arrangement of the packages. Whichever the case, at block 614, the system, e.g., by way of training module 108, may train the machine learning model (e.g., 116) based on the feedback (260). For example, training module 108 may compare an actual/ground truth arrangement of packages (or probability distribution over a plurality of 3D logical cells) to a candidate arrangement of packages (or candidate probability distribution over the plurality of 3D logical cells) to determine an error, and then use that error to train the machine learning model.

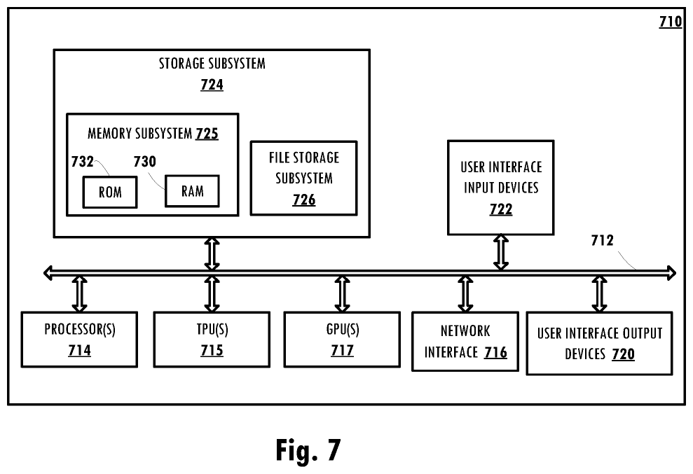

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. As shown in FIG. 7, in some implementations, computing device 710 may include additional logic that is optimized for executing machine learning-based computations, such as one or more tensor processing units (“TPUs”) 715 and/or one or more graphics processing units (“GPUs”) 717.

The peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the method of FIG. 6, as well as to implement various components depicted in FIGS. 1-2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by one or more processors and comprising:
identifying a heterogeneous plurality of packages to be loaded into an interior of a vessel;
determining, on an individual package basis, physical characteristics of the heterogeneous plurality of packages;
applying data indicative of the physical characteristics of the heterogeneous plurality of packages as input across a machine learning model to generate one or more outputs, wherein the machine learning model is trained based on historical examples of vessels being loaded with heterogeneous pluralities of packages;
based on one or more of the outputs, identifying one or more arrangements of the heterogeneous plurality of packages within the interior of the vessel; and
providing data indicative of one or more of the arrangements to one or more downstream computer-based actions.

2. The method of claim 1, wherein the interior of the vessel is logically divided into a three-dimensional (3D) array of logical cells, and the one or more outputs map the heterogeneous plurality of packages to the 3D array of logical cells.

3. The method of claim 2, wherein the one or more outputs comprise, for each logical cell of the 3D array of logical cells, one or more probabilities that one or more individual packages of the heterogeneous plurality of packages should physically occupy that logical cell.

4. The method of claim 1, wherein the one or more arrangements of the heterogeneous plurality of packages comprise a plurality of layers of the packages.

5. The method of claim 4, wherein the machine learning model is applied iteratively, with each iterative application of the machine learning model generating one or more of the outputs that represents a respective one of the plurality of layers of the packages.

6. The method of claim 5, wherein during a given iterative application of the machine learning model, data indicative of the physical characteristics of a subset of the heterogeneous plurality of packages already loaded into the vessel are excluded from being applied as input across the machine learning model.

7. The method of claim 1, wherein one or more of the downstream computer-based actions comprises rendering, on a display, a visual depiction of the of one or more of the arrangements of the heterogeneous plurality of packages.

8. The method of claim 1, wherein one or more of the downstream computer-based actions comprises rendering audio or visual output that conveys two or more arrangements of the heterogeneous plurality of packages as candidate arrangements, with each candidate arrangement being annotated with one or more assessments of the arrangement.

9. The method of claim 1, wherein one or more of the downstream computer-based actions comprises rendering, on one or more displays of an augmented reality (AR) display device, one or more annotations overlaying one or more digital images depicting the interior of the vessel, wherein the one or more annotations convey one or more aspects of one or more of the arrangements of the heterogeneous plurality of packages.

10. The method of claim 1, further comprising:
receiving feedback about one or more of the arrangements of the heterogeneous plurality of packages; and
training the machine learning model based on the feedback.

11. The method of claim 1, wherein the data indicative of the physical characteristics of the heterogeneous plurality of packages comprises individual masses of individual packages of the heterogeneous plurality of packages.

12. The method of claim 1, wherein the data indicative of the physical characteristics of the heterogeneous plurality of packages comprises individual volumes of the individual packages of the heterogeneous plurality of packages.

13. The method of claim 1, wherein in addition to the data indicative of the physical characteristics of the heterogeneous plurality of packages, data indicative of a spatial characteristic of the interior of vessel is also applied as input across the machine learning model.

14. The method of claim 1, wherein in addition to the data indicative of the physical characteristics of the heterogeneous plurality of packages, data indicative of scheduled downstream distribution of at least some of the packages is also applied as input across the machine learning model.

15. A system comprising one or more processors and memory storing instructions that, in response to execution by the one or more processors, cause the one or more processors to:
identify a heterogeneous plurality of packages to be loaded into an interior of a vessel;
determine, on an individual package basis, physical characteristics of the heterogeneous plurality of packages;
apply data indicative of the physical characteristics of the heterogeneous plurality of packages as input across a machine learning model to generate one or more outputs, wherein the machine learning model is trained based on historical examples of vessels being loaded with heterogeneous pluralities of packages;
based on one or more of the outputs, identify one or more arrangements of the heterogeneous plurality of packages within the interior of the vessel; and
provide data indicative of one or more of the arrangements to one or more downstream computer-based actions.

16. The system of claim 1, further comprising logically dividing the interior of the vessel into a three-dimensional (3D) array of logical cells, wherein the one or more outputs map the heterogeneous plurality of packages to the 3D array of logical cells.

17. The system of claim 16, wherein the one or more outputs comprise, for each logical cell of the 3D array of logical cells, one or more probabilities that one or more individual packages of the heterogeneous plurality of packages should physically occupy that logical cell.

18. The system of claim 15, wherein the one or more arrangements of the heterogeneous plurality of packages comprise a plurality of layers of the packages.

19. The system of claim 18, wherein the machine learning model is applied iteratively, with each iterative application of the machine learning model generating one or more of the outputs that represents a respective one of the plurality of layers of the packages.

20. At least one non-transitory computer-readable medium comprising instructions that, when executed by one or more processors, cause the one or more processors to:
identify a heterogeneous plurality of packages to be loaded into an interior of a vessel;
determine, on an individual package basis, physical characteristics of the heterogeneous plurality of packages;
apply data indicative of the physical characteristics of the heterogeneous plurality of packages as input across a machine learning model to generate one or more outputs, wherein the machine learning model is trained based on historical examples of vessels being loaded with heterogeneous pluralities of packages;
based on one or more of the outputs, identify one or more arrangements of the heterogeneous plurality of packages within the interior of the vessel; and
provide data indicative of one or more of the arrangements to one or more downstream computer-based actions.
